(19) United States
(12) Patent Application Publication
(10) Pub. No.: US 2020/0026268 A1
(43) Pub. Date: Jan. 23, 2020

(54) CONTROL DEVICE AND DIAGNOSIS SYSTEM

(71) Applicant: HITACHI, LTD., Chiyoda-ku, Tokyo (JP)

(72) Inventors: Masahiro MATSUBARA, Tokyo (JP); Shinji NAKAGAWA, Tokyo (JP)

(73) Assignee: HITACHI, LTD., Chiyoda-ku, Tokyo (JP)

(21) Appl. No.: 15/769,033

(22) PCT Filed: Oct. 17, 2016
(86) PCT No.: PCT/JP2016/080636

§ 371 Date: Apr. 17, 2018

(30) Foreign Application Priority Data
Nov. 11, 2015 (JP) 2015-220872

(51) Int. Cl. G05B 23/02

(52) U.S. Cl. CPC G05B 23/0235

(57) ABSTRACT

The purpose of the present invention is to provide a control device and a diagnosis system, with which a more reliable diagnosis can be achieved while taking advantage of respective characteristics of rule-based diagnosis and learning-based diagnosis. The present invention is equipped with: a first diagnosis unit for diagnosing a control function with use of output data from the control function in accordance with predetermined rules; a second diagnosis unit for diagnosing the control function with use of the output data in accordance with rules which are mechanically learned on the basis of the output data; and a comparison unit for comparing diagnosis results of the first and second diagnosis units with each other.

### TECHNICAL FIELD

The present invention relates to a control device and a diagnosis system for detecting abnormality of a control target of the control device.

### BACKGROUND ART

There are many systems, such as a plant, and au automobile, controlled by an electronic control device. A control device diagnoses for detecting abnormality of a control target and the control device itself, and a portent of the abnormality. The object of such diagnosis is to ensure safety by detecting malfunction, detect and deal with performance degradation, or deal with malfunction or performance degradation in advance by recognizing a portent thereof.

Conventionally, a diagnosis has been performed along predetermined criteria. For example, upper and lower limits are set in values measured by a sensor, and when a value departing from this range is measured, the value is considered as abnormality, and an alarm is issued. In this document, a diagnosis method using predetermined criteria in this way is referred to as a “rule-based diagnosis”. However, this method cannot deal with individual differences and usage of control systems, differences of environmental conditions, and temporal changes. That is, the method may decide as abnormality when it is not (false positive), or overlook abnormality (false negative).

In regard to the problem described above, recently, a method of diagnosing in accordance with characteristics of a control target by updating criteria from observed data, that is, through learning, is sometimes utilized. As criteria corresponding to learning, parameter updating of a physical model, utilizing of a statistical model, clustering, pattern recognizing such as a support vector machine, and the like are selected in accordance with characteristics of a diagnosis target. In this document, a diagnosis method of changing criteria in accordance with a target by learning in this way is referred to as a “learning-based diagnosis”.

A diagnosis method using learning can deal with individual differences and usage, differences of environmental conditions, and temporal changes. However, learning is not always successful. When learning fails, probability of false positive and false negative increases. Since a learning result is not ensured, it is not recognized that the method is more reliable than the rule-based diagnosis in which consideration in advance is sufficient.

There is a conventional technique of using property the rule-based diagnosis and the learning-based diagnosis having the characteristics described above to perform a diagnosis taking advantage of respective characteristics of the rule-based diagnosis and the learning-based diagnosis. The technique of Patent Literature 1 has a first diagnosis means of deciding a set of pieces of data acquired from a plurality of sensors largely deviating from normal data as abnormality, and a second diagnosis means of deciding abnormality from a sensor value departing from a predetermined range. The first diagnosis means is the learning-based diagnosis, and the second diagnosis means is the rule-based diagnosis. By this configuration, even when data is influenced by a maintenance work, and a decision result of the first diagnosis means indicates a false positive result, the first diagnosis means does not output and the second diagnosis means outputs when learning time is short, and thereby, wrong diagnosis result can be prevented.

### CITATION LIST

### Patent Literature

PTL 1: JP 5081998 B1

### SUMMARY OF INVENTION

### Technical Problem

However, when wrong determination is a performed by the learning-based diagnosis is not limited to a case with a clear event such as a maintenance work. For example, there is a case where appropriate learning is not performed depending on a parameter value related to learning. Thus, a more reliable diagnosis taking advantage of respective characteristics of rule-based diagnosis and learning-based diagnosis, is needed.

The purpose of the present invention is to provide a control device and a diagnosis system, with which a more reliable diagnosis can be achieved while taking advantage of respective characteristics of rule-based diagnosis and learning-based diagnosis.

### Solution to Problem

The present invention is equipped with: a first diagnosis unit for diagnosing a control function with use of output data from the control function in accordance with predetermined rules; a second diagnosis unit for diagnosing the control function with use of the output data in accordance with rules which are mechanically learned on the basis of the output data; and a comparison unit for comparing diagnosis results of the first and second diagnosis units with each other.

Otherwise, the present invention is equipped with: a first diagnosis unit for diagnosing a control function with use of output data from the control function equipped in a control device in accordance with predetermined rules; a second diagnosis unit for diagnosing the control function with use of the output data in accordance with rules which are mechanically learned on the basis of the output data; a result comparison unit for comparing diagnosis results of the first and second diagnosis units with each other and extracting non-identical diagnosis results; and a diagnosis rule update unit for updating at least the rule of the first diagnosis unit on the basis of the diagnosis result extracted in the result comparison unit.

### Advantageous Effects of Invention

According to the present invention, a more reliable diagnosis taking advantage of respective characteristics of rule-based diagnosis and learning-based diagnosis can be achieved.

### BRIEF DESCRIPTION OF DRAWINGS

FIG. 1 is a hardware configuration of a diagnosis system.

FIG. 2 is a function configuration of the diagnosis system.

FIG. 3 is a diagnosis processing flow of a controller side.

FIG. 4 is a processing flow of a server side for updating criteria.

FIG. 5 is input and output data of a diagnosis.

FIG. 6 is criteria of a rule-based diagnosis unit.

FIG. 7 is criteria of a learning-based diagnosis unit.

FIG. 8 is a difference in the criteria of the rule based diagnosis unit and the learning-based diagnosis unit.

FIG. 9 is display of a criteria plan of the rule-based diagnosis unit.

### DESCRIPTION OF EMBODIMENTS

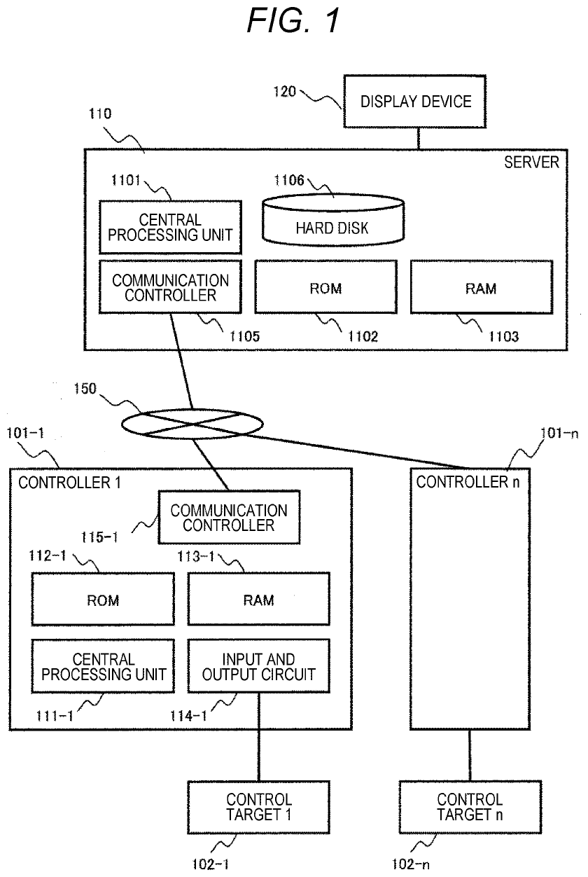

FIG. 1 illustrates a hardware configuration of a diagnosis system in which the present invention is applied. The diagnosis system is composed of a server, and a controller.

Controllers 101-1 to n are electronic control devices that control control targets 102-1 to n, respectively. The controllers 101-1 to n have central processing units 111-1 to n, read only memories (ROM) 112-1 to n, random access memories (RAM) 113-1 to n, input and output circuits 114-1 to n that perform input and output with the control targets 102-1 to n, and communication controllers 115-1 to n connected to a network 150. The type of the network may be the Internet, a mobile phone network, a FA network, or a complex thereof.

The server 110 has a central processing unit 1101, a ROM 1102, a RAM 1103, a communication controller 1105, and a hard disk 1106 that is a storage device having large capacity. The storage device having large capacity may be a solid state drive (SSD), or the like. The communication controller 1105 is connected to the network 150, and can communicate bi-directionally with the communication controllers 115-1 to n of the controllers 101-1 to n. A display device 120 is connected to the server 110. The display device is a device having a display screen such as a liquid crystal monitor.

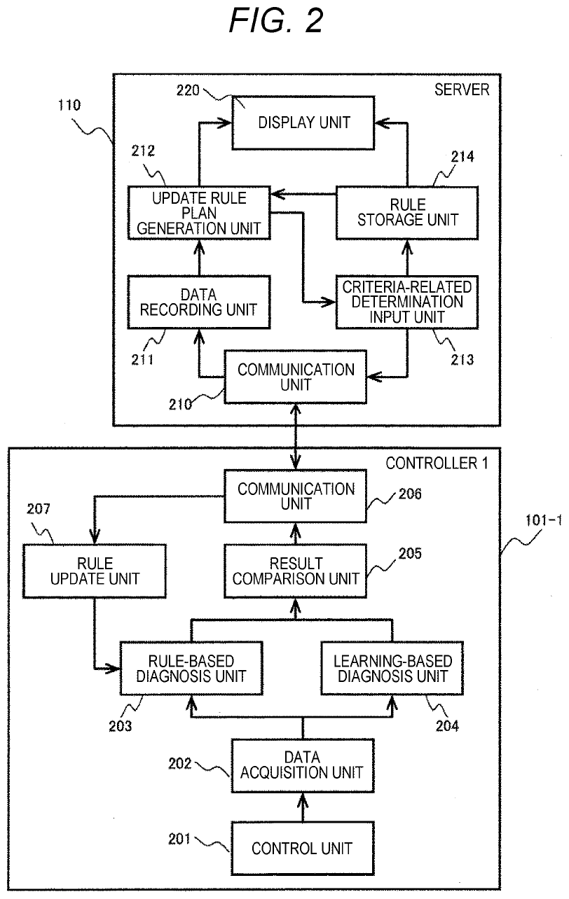

FIG. 2 illustrates a function configuration of the diagnosis system in which the present invention is applied. These functions are realized by software (a program). FIG. illustrates only a controller 1 (101-1). Since other controllers (101-2 to n) are similar to the controller 1 (101-1), they are not illustrated, and the controller 1 is representatively described in this document.

A control unit 201, a data acquisition unit 202, a rule-based diagnosis unit 203, a learning-based diagnosis unit 204, a result comparison unit 205, a communication unit 206, and a rule update unit 207 are arranged in the controller 101-1. These pieces of software are stored in the ROM 112-1, and the central processing unit 111-1 executes the software while using the RAM 113-1 as a storage region.

The server 110 is composed of a communication unit 210, a data recording unit 211, an update rule plan generation unit 212, a rule storage unit 213, a diagnosis method determination input 214, and a display unit 220. These pieces of software are stored in the ROM 1102, and the central processing unit 1101 executes the software while using the RAM 1103 and the hard disk 1106 as storage regions.

Each function of the controller 101-1 will be described below.

The control unit 201 performs input and output with the control target 102-1 via the input and output circuit 114-1 to perform control.

The data acquisition unit 202 acquires data that is a diagnosis target from among input and output data with the control target 102-1 held by the control unit 201, and internal data of the control unit 201, and stores the diagnosis target data. A flash memory not illustrated, or the like may be used in addition to the RAM 1103, for the storage.

The rule-based diagnosis unit 203 diagnoses on the basis of criteria predetermined as rules, by using the data for diagnosis acquired by the data acquisition unit 202. These rules are stored and held by the rule-based diagnosis unit 203. A diagnosis result of the rule-based diagnosis unit 203 is used for display of an alarm light, function degradation, safety operation, and the like in the controller 101-1.

The learning-based diagnosis unit 204 uses the data for diagnosis acquired by the data acquisition unit 202 to perform learning and diagnosis. That is, a diagnosis model as learning criteria is constructed, and the diagnosis is performed thereafter. As a construction method of the diagnosis model, for example, data decided to be normal by the rule-based diagnosis unit 203, in data of a certain period from a start of operation is used. Even after the diagnosis model is constructed, the diagnosis model is updated by using the data decided to be normal by the rule-based diagnosis unit 203 and the learning-based diagnosis unit 204.

The result comparison unit 205 decides the presence of a difference by comparing the diagnosis results for the same data, of the rule-based diagnosis unit 203 and the learning-based diagnosis unit 204.

The communication unit 206 makes sets of the data for diagnosis acquired by the data acquisition unit 202, and the diagnosis results of the rule-based diagnosis unit 203 and the learning-based diagnosis unit 204 for the data, to transmit all sets or sorted and selected sets to the server 110. The communication unit 206 transmits, at least data for diagnosis decided as having a difference in the diagnosis result by the result comparison unit 205, and diagnosis results of the rule-based diagnosis unit 203 and the learning-based diagnosis unit 204, via the communication controller 115-1.

The rule update unit 207 updates the criteria of the rule-based diagnosis unit 202 by using the data illustrating the criteria transmitted by the server 110 and received by the communication unit 206.

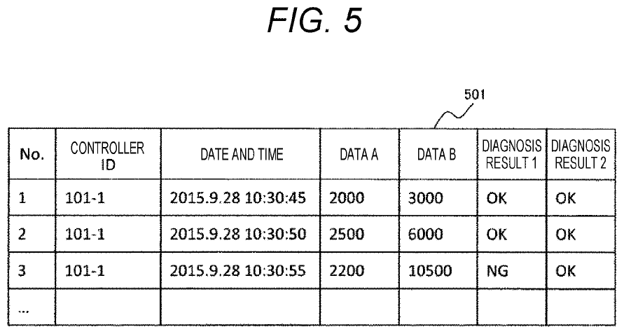

When the diagnosis model of the learning-based diagnosis unit 204 is a physical model or a statistical model, and a normal range can be clearly indicated (as illustrated in FIG. 5) as similar to the rule-based diagnosis, the normal range or an abnormal range may be transmitted to the server 110 via the communication unit 206.

Each function of the server 110 will be described below.

The communication unit 210 receives, data for diagnosis transmitted from the controllers 110-1 to n via the communication controller 1105, and diagnosis results of the rule-based diagnosis unit 203 and the learning-based diagnosis unit 204 for the data.

The data recording unit 211 makes sets of data for diagnosis and a diagnosis result received by the communication unit 210, and records the set in the RAM 113 and the hard disk 1106.

The update rule plan generation unit 212 generates a plan of new criteria of the rule-based diagnosis unit 203 from the data for diagnosis and the diagnosis result recorded in the data recording unit 211.

The criteria-related determination input unit 213 receives an input of whether the new criteria plan generated by the update rule plan generation unit 212 can be adopted, from a manager of the criteria. The criteria-related determination input unit 213 also receives an input of a modification plan of the criteria plan.

The rule storage unit 214 records the criteria input as being adoptable in the update rule plan generation unit 212, to the hard disk 1106. The communication unit 210 transmits the criteria input as being adoptable in the update rule plan generation unit 212 to the controllers 110-1 to n via the communication controller 1105. The update rule plan generation unit 212 sometimes refers to the current criteria recoded in the rule storage unit 214 when generating new criteria plan. The display unit 220 causes the display device 120 to display the criteria plan generated by the update rule plan generation unit 212, the current criteria recorded in the rule storage unit 214, the data for diagnosis recorded in the data recording unit 211, the diagnosis result, and the like. This display is viewed by the manager of the criteria. The display unit 220 also performs display for receiving of an input, by the criteria-related determination input unit 213.

The function of the server 110 may be arranged in the same controller as the controller (110-1) that acquires the diagnosis target data. Another controller capable of communicating via the network with the controller that acquires the diagnosis target data, may serve as the function. For example, the function may be a controller mounted in the same vehicle as the controller 110-1 and having a display device.

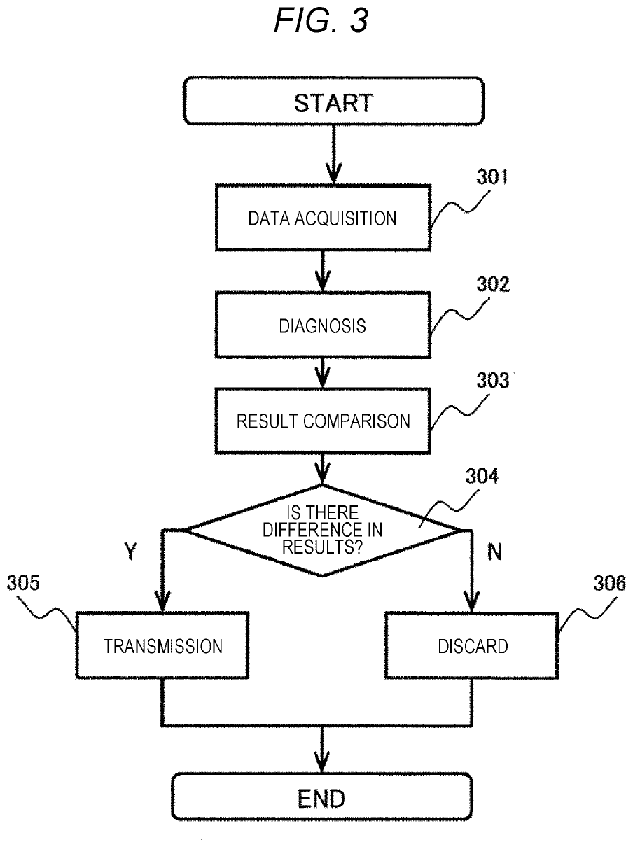

FIG. 3 illustrates a processing flow of a diagnosis program of a controller side of the present invention. This processing flow is a flow of when the data is transmitted to the server 110 only when there is a difference in the diagnosis results of the rule-based diagnosis unit 203 and the learning-based diagnosis unit 204.

Step 301: The data acquisition unit 202 acquires the diagnosis target data (input data of the diagnosis) from the control unit 201, to stores the data.

Step 302: The rule-based diagnosis unit 203 and the learning-based diagnosis unit 204 diagnose by using the data for diagnosis acquired by the data acquisition unit 202 at step 301.

Step 303: The result comparison unit 205 compares the diagnosis results for the same data, of the rule-based diagnosis unit 203 and the learning-based diagnosis unit 204 acquired at step 302, to decide the presence of a difference.

Step 304: From the comparison result of the result comparison unit 205 at step 303, the processing proceeds to step 305 if there is a difference, and proceeds to step 306 if there is no difference.

Step 305: The communication unit 206 transmits the data for diagnosis and the diagnosis result at step 302 to the server 110.

Step 306: The result comparison unit 205 discards the data for diagnosis and the diagnosis result at step 302.

One processing ends with the steps described above. This processing is performed when data is acquired in the data acquisition unit 202, or periodically.

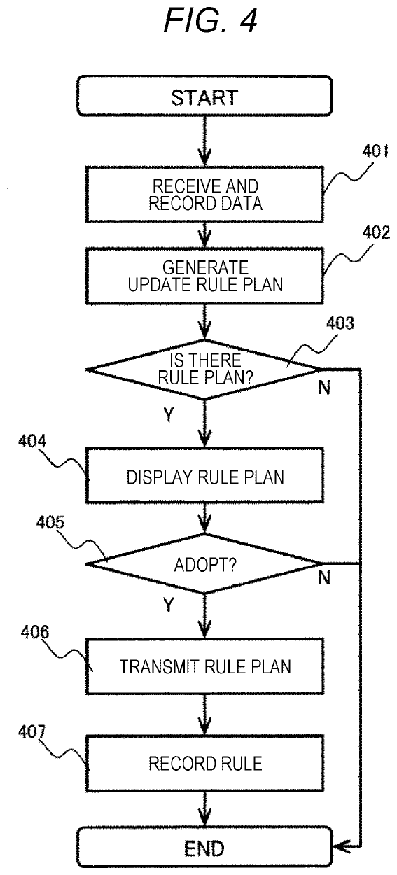

FIG. 4 illustrates a processing flow of a program of a server side of the present invention.

Step 401: The communication unit 210 receives, data for diagnosis transmitted from the controllers 110-1 to n, and diagnosis results of the rule-based diagnosis unit 203 and the learning-based diagnosis unit 204 for the data, and the data recording unit 211 associates the data with an ID of a controller that is a transmitting source, to record the data.

Step 402: The update rule plan generation unit 212 generates a new criteria plan of the rule-based diagnosis unit 203 on the basis of data acquired and recorded at step 410. The criteria are generated for each of the controllers 110-1 to n. The generation method will be described later.

Step 403: Whether generation of the update rule plan has been successful at step 402 is decided. If it has been successful, the processing proceeds to step 404, and if it has not been successful, the processing ends.

Step 404: the display unit 220 causes the display device 120 to display the update rule plan generated at step 402, and an ID of the target controller. The display 220 acquires the current criteria from the rule storage unit 214, to cause the display device 120 to display the current criteria.

Step 405: The criteria-related determination input unit 213 receives the input of whether the criteria plan generated at step 402 is adoptable. The processing proceeds to step 406 if it is input as adoptable, and the processing ends if it is input as not adoptable.

Step 406: The communication unit 210 transmits the criteria generated at step 402 to the controllers 110-1 to n.

Step 407: The rule storage unit 214 records the criteria transmitted at step 406, in the hard disk 1106 as the new current criteria. The current criteria are recorded in each of the controllers 110-1 to n.

One processing ends with the steps described above. This processing is performed when data is acquired in the communication unit 210, or periodically.

The data indicating the criteria transmitted at step 406 is received by the communication unit 206 of the controllers 110-1 to n, and is utilized by the rule update unit 207 for updating of the criteria of the rule-based diagnosis unit 203. The rule update unit 207 may notify the server 110 via the communication unit 206 when the criteria rules are received with no error, and when the update of the criteria is finished. The rule storage unit 214 may wait for this notification to record the transmitted criteria. Thereby, for the current criteria, record of the server 110 can be prevented from deviating from the actual criteria of the controllers 110-1 to n.

FIG. 5 illustrates a data configuration of a set of data acquired by the data acquisition unit 202 from the diagnosis target, and the diagnosis result thereof. This data configuration is similar in the data recorded by the data recording unit 211 in the server 110. In this document, a set of input data and output data (result) of the diagnosis is referred to as diagnosis data.

The diagnosis data is arranged in a time series order in a diagnosis data table 501. The diagnosis data includes a unique ID of a controller, a data measurement date, data acquired from the diagnosis target (in the present embodiment, data A, B), a diagnosis result 1 that is the diagnosis result of the rule-based diagnosis unit 203, and a diagnosis result 2 that is the diagnosis result of the learning-based diagnosis unit. The data measurement date is measured by a clock function included in the controller. The diagnosis results 1, 2 take three values of OK indicating normality, NG indicating abnormality, and NA indicating that a diagnosis is not available.

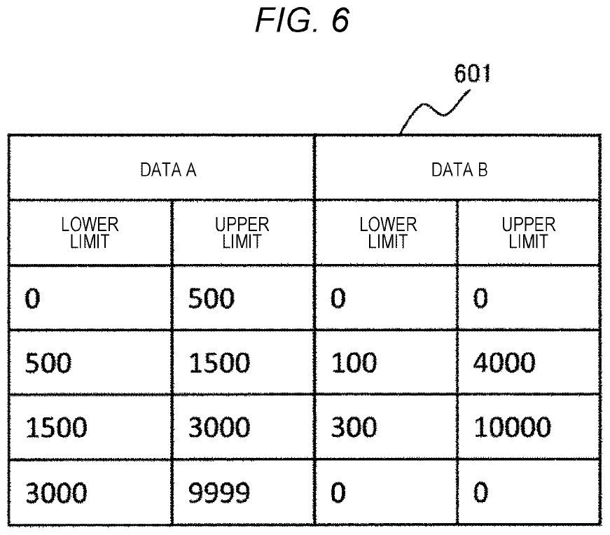

FIG. 6 illustrates the data of the criteria held by the rule-based diagnosis unit 203. A decision rule table 601 sets a range (upper and lower limits) for each of the data A and the data B that are the diagnosis targets. For example, it is set so that, when the value of the data A is 500 or more and less than 1500, the value of the data B should be 100 or more and 4000 or less, and the range of the data B is set for each region of the data A.

When the rule-based diagnosis unit 203 diagnoses, first, the rule-based diagnosis unit 203 uses the value of the data A that is the diagnosis target, to search lines corresponding to the upper and lower limits of the data A from the decision rule table 601. Next, the data B that is in a set with the data A is compared with the upper and lower limits of the data B indicated in the lines searched in the decision rule table 601. The diagnosis result is normal (OK) when the data B is within the upper and lower limits, and the diagnosis result is abnormal (NG) when the data B is not within the limits.

In data of the diagnosis data table 501, data of No. 1 and 2 are within the range of the decision rule table 601, and the diagnosis result 1 is OK. On the other hand, the data of No. 3 is not within the range of the decision rule table 601, and the diagnosis result is NG.

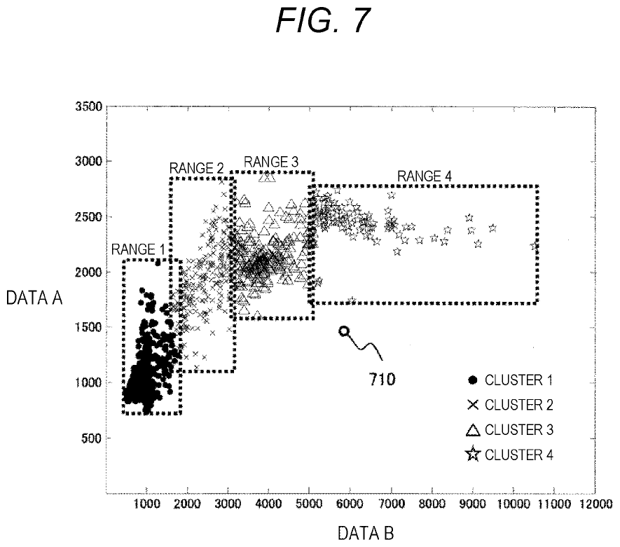

FIG. 7 illustrates a situation of learning of the learning-based diagnosis unit 204. In the present embodiment, range information acquired with clustering using a machine learning k-means method as a start point, is used as the diagnosis model. The generation method of this range information is as follows. First, clustering using the k-means method is performed with respect to a plurality of data sets that are the diagnosis target data, and division information is used. The division information refers to
a cluster number to which data divided by the k-means method belongs and
an average value (center vector) of data belonging to each cluster. The details of the k-means method are described in many documents, and are not described here. Next, the division information described above is used, and a range of values is set for each divided data set (cluster), and considered as range information. Particularly, the range refers to a lower limit value and an upper limit value of each dimension that define a range corresponding to each cluster (center vector). A setting method of this range information is as follows.—The minimum value of each dimension of the data belonging to each cluster is set to be the lower limit of each dimension of the range corresponding to each cluster.—The maximum value of each dimension of the data belonging to each cluster is set to be the upper limit of each dimension of the range corresponding to each cluster.

By the range setting method described above, when the number of dimensions of the diagnosis target data is 2, the range information becomes a rectangular shape. When the number of dimensions is 3, the range information forms a rectangular parallelepiped. In FIG. 7, the diagnosis target data is plotted with the vertical axis as the data A and the horizontal axis as the data B. With respect to this, the diagnosis target data is divided into clusters 1 to 4 in which the number of clusters is 4, by using the k-means method. From the division information of each cluster, ranges 1 to 4 are set as the range information.

In the diagnosis performed by the learning-based diagnosis unit 204, the data within these ranges 1 to 4 is diagnosed as normal (OK). For example, diagnosis target data 710 is data that has not observed at the time of learning, is an outlier with respect to the ranges 1 to 4, and therefore, is determined to be abnormal (NG).

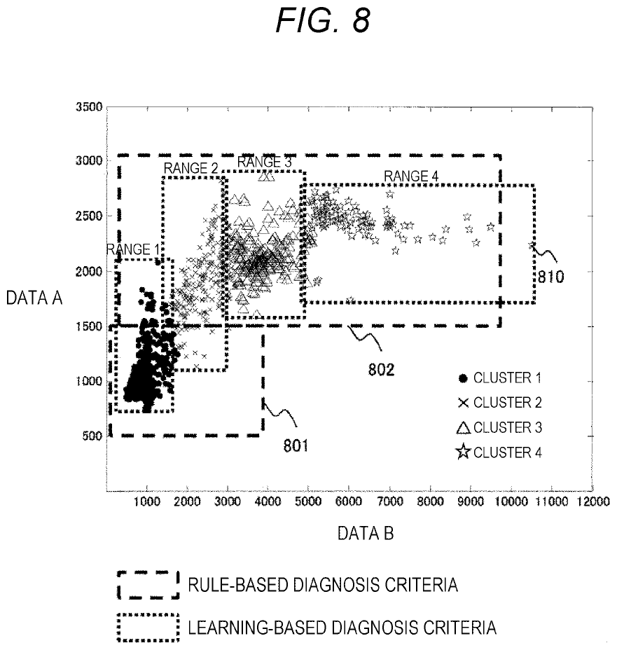

FIG. 8 indicates the criteria of the rule-based diagnosis unit 203 and the learning-based diagnosis unit 204 by overlapping the criteria with the diagnosis target data, and illustrates the difference of the criteria. The plotted diagnosis target data and the range information of the learning-based diagnosis unit 204 are the same as those in FIG. 7. The ranges 801 and 802 are criteria of the rule-based diagnosis unit 203, and are the same as contents of the decision rule table 601 in FIG. 6. What is clear from FIG. 8 is that the diagnosis target data 810 is determined to be abnormal (NG) in the rule-based diagnosis unit 203, and is determined to be normal (OK) in the learning-based diagnosis unit 204. Thus, when the same data as the diagnosis target data is observed, the result comparison unit 205 is extracted as data having a difference in the decision results, and this data is transmitted to the server 110. Such data is generated by individual differences of devices, environmental factors, or the like.

The update rule plan generation unit 212 generates new criteria from the diagnosis target data 810 transmitted to the server 110, and the current criteria of the rule-based diagnosis unit 203, that is, the decision rule table 601 recorded in the rule storage unit 214. Some examples of the generation method are described below. The generation method is not limited to these methods.

As the first method, a value is rewritten so that a range determined to be normal in the decision rule table 601 is expanded. When the diagnosis target data 810 is set to be (data A, data B)=(2250, 10500), the data corresponds to a line in which the data A is 500 or more and less than 3000 in the decision rule table 601. Thus, the upper limit of the data B of the corresponding line is set to be 10500. A margin may be included and for example, the upper limit may be set to be 11000. For the diagnosis target data 810, when the rule-based decision unit 203 determines the data to be normal (OK), and the learning-based diagnosis unit 204 determines the data to be abnormal (NG), the range is narrowed than the current range, conversely. This is similar also in the second method.

As the second method, when the range information of the learning-based diagnosis unit 204 is transmitted to the server 110, the range in which the data is decided to be normal in the decision rule table 601 is expanded for a portion corresponding to the range information. For example, the range of the range information 802 in which the diagnosis target data 810 is included is 1700 or more and less than 2800 for the data A, and 4800 or more and 10500 or less for the data B. In this case, the normal range of the data B is updated only for a portion in which the data A is 1700 or more and less than 2800. Then, the lower limit of the data B is not changed from 300, and the upper limit is expanded to 10500.

As the third method, when the range information of the learning-based diagnosis unit 204 is transmitted to the server 110, the range information is considered as a criteria plan that is replaced with the decision rule table 601.

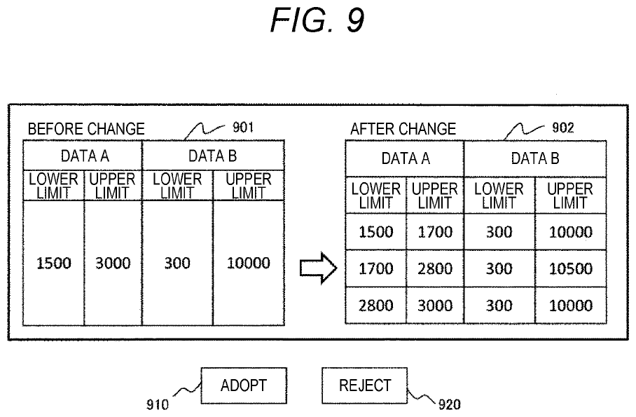

FIG. 9 illustrates the criteria plan by the update rule plan generation unit 212, and input receiving by the criteria-related determination input unit 213, that are drawn in the display device 210. The decision rule tables 901 and 902 indicate criteria of before the change and after the change (the update plan), respectively. Not the entire decision rule table 601, but only a portion in which the change occurs is indicated. The update plan is along the second method described above. A value in the decision rule table 902 can be rewritten by using an input device such as a keyboard connected to the server 110, by the manager of the criteria. This corresponds to the input reception of a modification plan of the criteria by the criteria-related determination input unit 213.

When the manager presses a button 910 “adopt”, the criteria plan is considered to be adoptable, by the criteria-related determination input unit 213. When the manager presses a button 920 “discard”, the criteria plan is discarded, by the criteria-related determination input unit 213.

When the button 910 is pressed, and the criteria of the rule-based diagnosis unit 203 is updated, after that, even when the same data as the diagnosis target data 810 is observed, the data is not decided to be abnormal (NG). Similarly, a configuration is also enabled in the present invention, in which, when it is decided to be normal (OK) in the rule-based diagnosis unit 203, and there is data decided to be abnormal (NG) in the learning-based diagnosis unit 204, the criteria of the rule-based diagnosis unit 203 is updated so that the data is decided to be abnormal (NG).

By the control device and the diagnosis system according to the present embodiment, a more reliable diagnosis can be achieved while taking advantage of respective characteristics of rule-based diagnosis and learning-based diagnosis. Particularly, the rule-based diagnosis that has high reliability is used for determining diagnosis. However, an event that is not dealt with by the rule-based diagnosis, that is, an event in which decision of false positive or false negative may be performed, is extracted by the learning-based diagnosis, and the criteria of the rule-based diagnosis can be updated. In the update plan of the criteria of the rule-based diagnosis, a work considered by a person is facilitated. Thereby, individual differences and usage of control systems, differences of environmental conditions, and temporal changes are dealt with, and accuracy and reliability of the diagnosis can be maintained higher.

As described above, the decision of updating the criteria of the rule-based diagnosis is performed by an expert, and thereby, diagnosis can be performed in which individual differences and usage of control systems, differences of environmental conditions, and temporal changes are dealt with, while a case in which wrong decision is performed by the learning-based diagnosis is eliminated.

Recently, update of software is performed via a network. However, after the update of software with improvement or modification of control algorithm, a diagnosis method also needs to be updated. This case where the update of the diagnosis method is not sufficient, also can be detected.

In the present embodiment, the result comparison unit 205 extracts the diagnosis data having a difference in the diagnosis results of the rule-based diagnosis unit 203 and the learning-based diagnosis unit 204, and transmits the data to the server 110. Thereby, a communication band and a data holding region are made smaller than those of when all diagnosis data is transmitted. However, the present invention does not limit so that the diagnosis data having no difference in the diagnosis result is transmitted, is displayed as FIG. 8 in the display device 120, and is utilized by the update rule plan generation unit 212.

In the embodiment described above, the result comparison unit 205 is arranged in the controllers 110-1 to n. However, the diagnosis data may be transmitted to the server 110 without being sorted, and the result comparison unit 205 may be arranged in the next stage of the communication unit 210 of the server 110.

In the embodiment described above, the learning of the learning-based diagnosis unit 204 is performed in the controllers 110-1 to n. However, the diagnosis target data may be transmitted to the server 110 without being sorted, and the learning may be performed in the server 110 side. The controllers 110-1 to n download the learning result (in the present embodiment, range information) from the server 110, to perform decision only. In this case, a function of updating the learning result of the learning-based diagnosis unit 204 as similar to the rule update unit 207 with respect to the rule-based diagnosis unit 203, is arranged in the controllers 110-1 to n, and the learning result is acquired from the communication unit 206 to update the criteria of the learning-based diagnosis unit 204. The advantage of this method is that a processing load of a controller can be decreased by performing learning having a large processing load by a server.

In the present embodiment, a model of the learning-based diagnosis is constructed for each control target. However, when learning is performed by a server, one model of the learning-based diagnosis may be constructed from data of plurality of control targets. The plurality of control targets of this time are devices of the same type, for example, engines of the same type. The advantage of this method is that data acquired only by a few control targets, and acquired in a condition occurring only in specific use environment and usage, and insufficient point of the criteria of the rule-based diagnosis that is found from the data, can be shared also by the diagnosis of the other control targets, and a wrong diagnosis can be prevented in advance. In addition, the number of inputting in the criteria-related determination input unit 213 can be decreased.

1. A control device comprising:
a first diagnosis unit for diagnosing a control function with use of output data from the control function in accordance with predetermined rules;
a second diagnosis unit for diagnosing the control function with use of the output data in accordance with rules which are mechanically learned on the basis of the output data; and
a comparison unit for comparing diagnosis results of the first and second diagnosis units with each other.

2. The control device according to claim 1, wherein the result comparison unit is configured to extract a case where a diagnosis result of the first diagnosis unit and a diagnosis result of the second diagnosis unit are different.

3. The control device according to claim 1, wherein the result comparison unit is configured to extract a case where a diagnosis result of the first diagnosis unit indicates normal and a diagnosis result of the second diagnosis unit indicates abnormal.

4. A diagnosis system composed of the control device according to claim 1, and a center to which the control device is connected,
the center comprising a data collection unit that collects the extracted output data, a diagnosis rule update unit that updates rules used in the first diagnosis unit on the basis of the output data collected, and a rule transmission unit that transmits updated rules to the control device.

5. A diagnosis system comprising:
a first diagnosis unit for diagnosing a control function with use of output data from the control function equipped in a control device in accordance with predetermined rules;
a second diagnosis unit for diagnosing the control function with use of the output data in accordance with rules which are mechanically learned on the basis of the output data;
a result comparison unit for comparing diagnosis results of the first and second diagnosis units with each other and extracting non-identical diagnosis results; and
a diagnosis rule update unit for updating at least the rules of the first diagnosis unit on the basis of the diagnosis result extracted in the result comparison unit.

6. The diagnosis system according to claim 5 comprising an update rule plan generation unit that generates a new criteria plan from the output data and the diagnosis result.

7. The diagnosis system according to claim 6 comprising a criteria-related determination input unit that receives an input of whether the new criteria plan generated by the update rule plan generation unit can be adopted.
